(19) United States
(12) Patent Application Publication
(10) Pub. No.: US 2026/0314838 A1
(43) Pub. Date: Oct. 15, 2026

(54) DUAL RAIL MATTRESS ASSEMBLY

(71) Applicant: Jeffco Foam, LLC, Webster, MA (US)

(72) Inventor: Eric B. Lonstein, Wellesley, MA (US)

(73) Assignee: Jeffco Foam, LLC, Webster, MA (US)

(21) Appl. No.: 19/645,776

(22) Filed: Apr. 13, 2026

Related U.S. Application Data
(60) Provisional application No. 63/788,524, filed on Apr. 14, 2025.

(51) Int. Cl. A47C 23/00

(52) U.S. Cl. CPC A47C 23/007

(57) ABSTRACT

A mattress assembly includes a first inner core and a first set of rails disposed about a perimeter of the first inner core. A top planar surface of the first set of rails is coplanar with a top planar surface of the first inner core and positioned between about 2 and 6 inches from a top surface of the mattress assembly. The mattress assembly also includes a second inner core and a second set of rails disposed about a perimeter of the second inner core. A bottom planar surface of the second set of rails is coplanar with a bottom planar surface of the second inner core and positioned between about 1 and 3 inches from a bottom surface of the mattress assembly. The first set of rails is vertically stacked above the second set of rails to provide dual rail edge support throughout a height of the mattress assembly.

### CROSS-REFERENCE TO RELATED APPLICATIONS

This application claims priority to and benefit of U.S. Provisional Application No. 63/788,524, filed on Apr. 14, 2025, entitled DUAL RAIL MATTRESS ASSEMBLY, the entire contents of which are incorporated herein by reference for all purposes.

### FIELD

The present disclosure relates generally to mattresses and, more particularly, to coil or foam mattress assemblies having dual side rail support systems for enhanced edge support.

### BACKGROUND

Mattresses are typically designed for pressure management and comfort. When an individual lies on a mattress, the internal support structure ideally distributes the individual’s body weight evenly across the entire sleeping surface to reduce uncomfortable pressure points. Conventional mattresses are typically constructed using layers of foam and/or coils. Current foam and coil mattresses often provide side rails about one or more perimeters of the mattress to create a frame around the inner core structure of the mattress. These rails serve several functions, including shaping the corners of the mattress, providing lateral support to the inner core structure to prevent the inner core structure from spreading under the weight of an individual, and providing a sturdy sitting edge on the mattress.

### SUMMARY

Typical side rails that encase a foam or coil inner core of a mattress are positioned between about one and nine inches from the bottom of the mattress. However, this rail positioning can be problematic in mattresses that are 12 inches or greater in height. For example, in a mattress that is 16 inches tall, the rails would typically be positioned six or more inches from the comfort foams at the top of the mattress, leading to little edge support. Therefore, a need exists for a mattress constructed with side rails that are adequate to support mattresses that are greater than 12 inches in height.

This disclosure describes a mattress that has two sets of side rails encasing a foam or coil inner core. In some embodiments, the first set of rails may be between about 2 and 6 inches from the top surface of the mattress, while the second set of rails may be between about 1 and 3 inches from the bottom of the mattress. This dual rail approach provides a system that positions support rails at both the upper and lower regions of the mattress, thereby ensuring comprehensive edge support throughout the entire height of the mattress assembly. Advantageously, the dual rail system can be used with any type of foam or coil mattress where two layers of edge support are desired.

Embodiments of the dual rail mattress assembly of this disclosure may include one or more of the following, in any suitable combination.

Embodiments of a mattress assembly of this disclosure include a first inner core and a first set of rails disposed about a perimeter of the first inner core for supporting an edge thereof. A top planar surface of each of the first set of rails is coplanar with a top planar surface of the first inner core and positioned between about 2 and 6 inches from a top surface of the mattress assembly. The mattress assembly also includes a second inner core and a second set of rails disposed about a perimeter of the second inner core for supporting an edge thereof. A bottom planar surface of each of the second set of rails is coplanar with a bottom planar surface of the second inner core and positioned between about 1 and 3 inches from a bottom surface of the mattress assembly. The first inner core with the first set of rails is vertically stacked above the second inner core with the second set of rails to provide dual rail edge support throughout a height of the mattress assembly. The height of the mattress assembly is at least 12 inches.

In further embodiments, the mattress assembly includes one or more upper layers positioned above the top planar surface of each of the first set of rails and one or more intermediate layers positioned between the first set of rails and the second set of rails. In embodiments, a height of each of the first set of rails is between about 2 and 6 inches. In embodiments, a height of each of the second set of rails is between about 4 and 8 inches. In embodiments, a width of each of the first and second set of rails is between about 2 and 6 inches. In embodiments, each of the first and second set of rails is made of a flexible polyurethane foam. In embodiments, each of the first and second set of rails has a density of between about 1.5 and 2.5 pcf. In embodiments, each of the first and second set of rails has an indention load deflection (ILD) of between about 28 and 60 pounds-force. In embodiments, the first set of rails includes four rails disposed about the perimeter of the first inner core, and the second set of rails includes four rails disposed about the perimeter of the second inner core. In embodiments, the first set of rails and the second set of rails are vertically aligned along a perimeter of the mattress assembly. In embodiments, the first inner core and the second inner core are vertically stacked within the mattress assembly.

Embodiments of a method of providing edge support in a mattress assembly of this disclosure includes disposing a first set of rails about a perimeter of a first inner core such that a top planar surface of each of the first set of rails is coplanar with a top planar surface of a first inner core. The method also includes positioning the first inner core with the first set of rails within the mattress assembly such that the top planar surface of each of the first set of rails is between about 2 and 6 inches from a top surface of the mattress assembly. The method also includes disposing a second set of rails about a perimeter of a second inner core such that a bottom planar surface of each of the second set of rails is coplanar with a bottom planar surface of the second inner core. The method also includes positioning the second inner core with the second set of rails within the mattress assembly such that the bottom planar surface of each of the second set of rails is between about 1 and 3 inches from a bottom surface of the mattress assembly. The mattress assembly has a total height of at least 12 inches.

In further embodiments, the method also includes positioning one or more intermediate layers between the first set of rails and the second set of rails. In embodiments, the method also includes positioning one or more upper layers above the top planar surface of each of the first set of rails. In embodiments, the method also includes vertically aligning the first set of rails and the second set of rails along a perimeter of the mattress assembly. In embodiments, the method also includes vertically stacking the first inner core and the second inner core within the mattress assembly.

Embodiments of a method of manufacturing a mattress assembly of this disclosure include cutting flexible polyurethane foam having a density of between about 1.5 and 2.5 pcf and an indention load deflection (ILD) of between about 28 and 60 pounds-force to form a first set of rails, each rail of the first set of rails having a height of between about 2 and 6 inches and a width of between about 2 and 6 inches. The method also includes disposing the first set of rails about a perimeter of a first inner core such that a top planar surface of each of the first set of rails is coplanar with a top planar surface of the first inner core, thereby forming a first support layer. The method also includes cutting flexible polyurethane foam having a density of between about 1.5 and 2.5 pcf and an ILD of between about 28 and 60 pounds-force to form a second set of rails, each rail of the second set of rails having a height of between about 4 and 8 inches and a width of between about 2 and 6 inches. The method also includes disposing the second set of rails about a perimeter of a second inner core such that a bottom planar surface of each of the second set of rails is coplanar with a bottom planar surface of the second inner core, thereby forming a second support layer. The method also includes positioning one or more upper layers above the first support layer such that the top planar surface of each of the first set of rails is between about 2 and 6 inches from a top surface of the mattress assembly. The method also includes positioning one or more base layers below the second support layer such that the bottom planar surface of each of the second set of rails is between about 1 and 3 inches from a bottom surface of the mattress assembly. The mattress assembly provides dual rail edge support at both an upper region and a lower region thereof.

In further embodiments, the method also includes positioning one or more intermediate layers between the first set of rails and the second set of rails. In embodiments, the method also includes vertically aligning the first set of rails and the second set of rails along a perimeter of the mattress assembly. In embodiments, the method also includes vertically stacking the first inner core and the second inner core within the mattress assembly.

A reading of the following detailed description and a review of the associated drawings will make apparent these and other features and advantages. Both the foregoing general description and the following detailed description are explanatory only and are not restrictive of aspects as claimed.

### BRIEF DESCRIPTION OF THE DRAWINGS

The disclosure will be more fully understood by reference to the detailed description, in conjunction with the following figures, wherein:

FIG. 1 illustrates a perspective, exploded view of a mattress assembly, according to an embodiment of the disclosure;

FIG. 2 is a flow-chart of a method of providing edge support in a mattress assembly, according to an embodiment of the disclosure; and

FIG. 3 is a flow-chart of a method of manufacturing a mattress assembly, according to an embodiment of the disclosure.

### DETAILED DESCRIPTION

In the description that follows, like components have been given the same reference numerals, regardless of whether they are shown in different embodiments. To illustrate embodiment(s) in a clear and concise manner, the drawings may not necessarily be to scale, and certain features may be shown in somewhat schematic form. Features that are described and/or illustrated with respect to one embodiment may be used in the same way or in a similar way in one or more other embodiments and/or in combination with or instead of the features of the other embodiments.

As used in the specification and claims, for the purposes of describing and defining the invention, the terms “substantially” or “approximately” are used to represent the inherent degree of uncertainty that may be attributed to any quantitative comparison, value, measurement, or other representation. The terms “substantially” or “approximately” are also used herein to represent the degree by which a quantitative representation may vary from a stated reference without resulting in a change in the basic function of the subject matter at issue. While the terms “substantially” or “approximately” are not limited to a specific variation and may cover any variation that is understood by one of ordinary skill in the art to be an acceptable level of variation, some examples are provided as follows. In one example, the term substantially or approximately may include a variation of less than 10% of the dimension or quantity. In another example, the term substantially or approximately may include a variation of less than 5%. If the term “substantially” or “approximately” is used to define the angular relationship of one element to another element, one non-limiting example of the term substantially or approximately may include a variation of 5 degrees or less. These examples are not intended to be limiting and may be increased or decreased based on the understanding of acceptable limits to one of skill in the relevant art.

Unless specifically stated or obvious from context, the term “about” is understood as within a range of normal tolerance in the art. Unless otherwise clear from context, all numerical values provided herein are modified by the term “about.” Provided ranges are understood to be shorthand for all the values within the range. “Comprise,” “include,” and/or plural forms of each are open ended and include the listed parts and can include additional parts that are not listed. “And/or” is open-ended and includes one or more of the listed parts and combinations of the listed parts. Use of the relative terms “top,” “bottom,” “above,” “below” and the like helps only in the clear description of the disclosure and does not limit the structure, positioning and/or operation of the disclosure in any manner.

The terms “first,” “second,” “third,” and “fourth,” among other numeric values, may be used in this disclosure. It will be understood that, unless otherwise noted, those terms are used in their relative sense only. In particular, certain components may be present in interchangeable and/or identical multiples (e.g., pairs). For these components, the designation of first, second, third, and/or fourth may be applied to the components merely as a matter of convenience in the description.

Terms such as “a,” “an,” and “the,” are not intended to refer to only a singular entity, but also include the general class of which a specific example may be used for illustration. The terms a, an, and the, may be used interchangeably with the term at least one. The phrases at least one of and comprises at least one of followed by a list refers to any one of the items in the list and any combination of two or more items in the list. All numerical ranges are inclusive of their endpoints and non-integer values between the endpoints unless otherwise stated.

For purposes of the disclosure, directional terms are expressed generally with relation to a standard frame of reference when the aspects or articles described herein are in an in-use orientation.

Conventional mattress designs face a significant challenge in providing adequate edge support for taller mattresses, particularly those having a height of 12 inches or greater. In traditional mattress constructions, side rails are typically positioned in a single layer near the bottom of the mattress, generally between about one and seven inches from the bottom surface. While this single-rail configuration may provide sufficient edge support for mattresses of standard height, it becomes increasingly inadequate as mattress height increases.

In taller mattresses, such as those measuring 16 inches or more in height, the conventional single-rail positioning places the rails at a substantial distance—often six or more inches—from the comfort foams at the top of the mattress. This configuration results in several problems: (1) insufficient support at the upper edge of the mattress where users typically sit or recline; (2) premature sagging and deformation of the mattress edges over time; (3) a sensation of instability when users sit at the edge of the bed; and (4) reduced overall longevity of the mattress structure.

The present disclosure addresses these problems by providing a dual rail system that positions support rails at both the upper and lower regions of the mattress, thereby ensuring comprehensive edge support throughout the entire height of the mattress assembly.

### Example 1: 16-Inch Mattress Assembly with Dual Rail Support

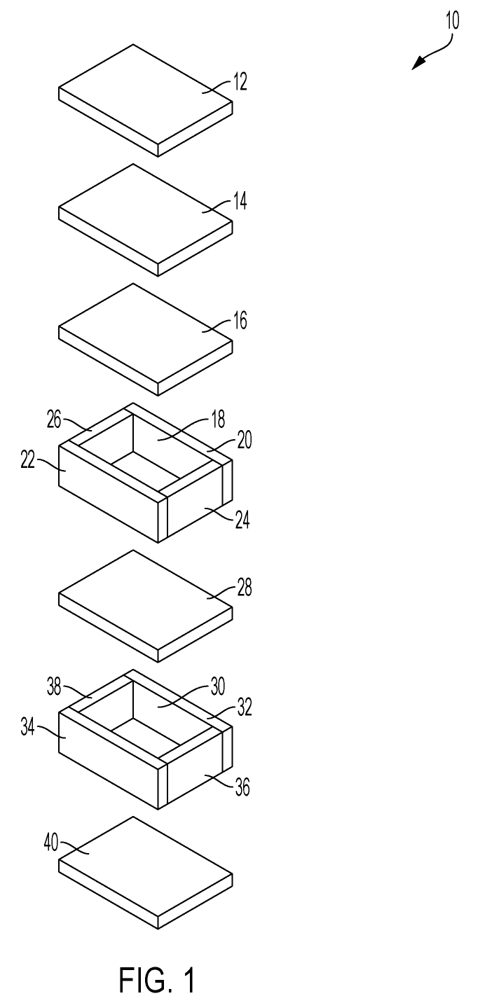

FIG. 1 illustrates a perspective, exploded view of a mattress assembly 10, according to a first example of the disclosure. In this example, the mattress assembly 10 may form the layers of a 16-inch mattress, demonstrating how the dual rail system provides enhanced edge support for taller mattresses.

As shown in FIG. 1, a first layer 12 of the mattress assembly 10 may comprise the upper surface of the mattress, which may be made of a thin layer of fabric, such as polyester, cotton, silk, or blends thereof. A second layer 14 of the mattress assembly 10 positioned beneath the first layer 12 may comprise foam (e.g., memory foam, high-resilience polyurethane foam), gels, or batting. A third layer 16 of the mattress assembly 10 positioned beneath the second layer 14 may comprise foam, coil, or combinations thereof. A fourth layer 18 of the mattress assembly 10 positioned beneath the third layer 16 may comprise a first set of four rails 20, 22, 24, 26, which are configured to be disposed about and encase a first inner core (not shown). The first inner core can also be comprised of foam, coil, or combinations thereof. In this example, the rails 20, 22 may extend along an entire length of the mattress assembly 10, while the rails 24, 26 extend along the width of the mattress assembly 10 between the rails 20, 22. Alternatively, the rails 24, 26 may extend along an entire width of the mattress assembly 10 while the rails 20, 22 may extend along a length of the mattress assembly 10 between the rails 24, 26. In either example, the rails 20, 22, 24 and 26 together may be disposed about a perimeter of the first and second inner cores for supporting an edge thereof. A width of each of the first set of rails 20, 22, 24, 26 may be between about 2 and 6 inches, while a height of each of the first set of rails 20, 22, 24, 26 may also be between about 2 and 6 inches. In some examples, a height of each of the first set of rails is approximately three inches. The first set of rails 20, 22, 24, 26 may be positioned within the mattress assembly such that a top planar surface is coplanar to a top planar surface of the first inner core that the first set of rails 20, 22, 24, 26 surrounds.

In this example, the fourth layer 18 may be positioned within the mattress assembly 10 such that the top planar surface of each of the first set of rails 20, 22, 24, 26 is between about 2 and 6 inches from the top of the mattress assembly 10. For example, a height of the first layer 12 may be about 0.5 inches, a height of the second layer 14 may be about 1.5 inches, and a height of the third layer 16 may be about 1 inch. However, the heights of each of the first layer 12, the second layer 14, and the third layer 16 may vary as long as the fourth layer 18 is positioned between about 2 and 6 inches from the top surface of the mattress assembly 10 in order to provide adequate edge support.

At least one intermediate fifth layer 28 of the mattress assembly 10 may be positioned beneath the fourth layer 18 and may comprise foam. Examples of the foam may be punched or ventilated. A height of the fifth layer 28 may be about 1.5 inches in this example. A sixth layer 30 of the mattress assembly 10 may be positioned beneath the fifth layer 28 and may comprise a second set of four rails 32, 34, 36, 38, which are configured to be disposed about and encase a second inner core made of foam or coil (not shown). As such, the first set of rails and the second set of rails may be vertically aligned along a perimeter of the mattress assembly 10. In this example, the rails 32, 34 may extend along an entire length of the mattress assembly 10, while the rails 36, 38 may extend along the width of the mattress assembly 10 between the rails 32, 34. Alternatively, the rails 36, 38 may extend along an entire width of the mattress assembly 10 while the rails 32, 34 may extend along a length of the mattress assembly 10 between the rails 36, 38. In either example, the rails 32, 34, 36, 38 together may be disposed about a perimeter of the second inner core for supporting an edge thereof.

A width of each of the second set of rails 32, 34, 36, 38 may be between about 2 and 6 inches, while a height of each of the second set of rails 32, 34, 36, 38 may be between about 4 and 8 inches. In some examples, a height of each of the second set of rails 32, 34, 36, 38 is approximately six inches. The second set of rails 32, 34, 36, 38 may be positioned within the mattress assembly 10 such that the bottom planar surface of each of the second set of rails 32, 34, 36, 38 is coplanar to a bottom planar surface of the second inner core that the second set of rails 32, 34, 36, 38 surrounds. As such, the first inner core with the first set of rails 20, 22, 24, 26 is vertically stacked above the second inner core with the second set of rails 32, 34, 36, 38 to provide dual rail edge support throughout a height of the mattress assembly.

In this example, the sixth layer 30 may be positioned within the mattress assembly 10 such that the bottom planar surface of each of the second set of rails 32, 34, 36, 38 is between about 1 and 3 inches from the bottom surface of the mattress assembly 10. For example, a seventh and bottom layer 40 of the mattress assembly 10 may be positioned beneath the sixth layer 30 and may comprise foam, coils, or combinations thereof. A height of the seventh layer 40 may be about 2.5 inches. The mattress assembly 10 can further include one or more additional layers that can overlap the top planar surfaces of each of the layers 14, 16, 18, 28, 30, and 40.

The foam in the one or more foam layers and/or cores can include polyurethane foams, latex foams including natural, blended and synthetic latex foams, polystyrene foams, polyethylene foams, polypropylene foam, polyether-polyurethane foams, and the like. The foams can be formed from viscoelastic or non-viscoelastic foams. Some viscoelastic materials may be temperature sensitive, thereby enabling the foam layer to change hardness/firmness based in part upon the temperature of the supported part. Any of these foams may be open cell or closed cell, or a hybrid structure of open cell and closed cell. Likewise, the foams can be reticulated, partially reticulated or non-reticulated foams. The term reticulation generally refers to removal of cell membranes to create an open cell structure that is open to air and moisture flow. The foams may also be gel infused. The foams can include one or more channels for improved air flow. Each of the foam layers and/or cores, where present, can be formed of the same material configured with different properties or can be formed of different materials from others of the foam layers and/or cores.

The different properties for each foam layer and/or core may include, but are not limited to, density, hardness, thickness, support factor, flex fatigue, air flow, and various combinations thereof. Density is a measurement of the mass per unit volume and is commonly expressed in pounds per cubic foot (pcf). Density is measured herein in accordance with ASTM D-3574. The hardness properties of foam are referred to herein as the indention load deflection (ILD) and is also measured herein in accordance with ASTM D-3574. In the case of multiple foam layers and/or cores, the density and hardness properties can be varied or be the same. Moreover, combinations of properties of each layer and/or core may be varied for each individual layer or core.

In some embodiments of the disclosure, the hardness property of the foam layers and/or cores may have an ILD within a range of between about 8 and 35 pounds-force. In some embodiments, the foam layers and/or cores can have a density of between about 1.5 and 4 pounds pcf. In some embodiments, the first set of rails 20, 22, 24, 26 and/or the second set of rails 32, 34, 36, 38 may be made of cut flexible polyurethane foam that has a density of between about 1.5 and 2.5 pcf and an ILD ranging between about 28 and 60 pounds-force.

### Example 2: 12-Inch Mattress Assembly with Optimized Rail Heights

In a second example of the disclosure, the dual rail mattress assembly 10 is configured to have a total height of 12 inches. In this example, the first set of rails 20, 22, 24, 26 may have a height of about 2 inches and may be positioned such that the top planar surface is about 2 inches from the top of the mattress assembly 10. The second set of rails 32, 34, 36, 38 may have a height of about 4 inches and may be positioned such that the bottom planar surface is about 1 inch from the bottom of the mattress assembly 10. This configuration demonstrates that the heights of each rail set may be adjusted based on the overall height of the mattress assembly 10 while maintaining the dual rail principle. In this 12-inch configuration, the combined support from both rail sets provides comprehensive edge support throughout the mattress height, preventing the edge sagging issues that would occur with a conventional single-rail design at this height. The intermediate foam layers 28 between the first and second rail sets in this example may comprise viscoelastic foam to provide additional comfort properties while maintaining structural integrity at the edges. The first inner core surrounded by the first set of rails 20, 22, 24, 26 may comprise foam, while the second inner core surrounded by the second set of rails 32, 34, 36, 38 may comprise coil springs to provide additional support in the lower portion of the mattress assembly 10.

### Example 3: 20-Inch Premium Mattress Assembly with Enhanced Rail Specifications

In a third example of the disclosure, the dual rail mattress assembly 10 may be configured for a 20-inch premium mattress. In this example, the first set of rails 20, 22, 24, 26 may have a height of about 4 inches and may be positioned such that the top planar surface is about 4 inches from the top of the mattress assembly 10. The second set of rails 32, 34, 36, 38 may have a height of about 8 inches and may be positioned such that the bottom planar surface is about 3 inches from the bottom of the mattress assembly 10. This configuration demonstrates the scalability of the dual rail system to accommodate extra-tall mattress designs. The increased rail heights in this example provide proportionally greater edge support for the larger mattress structure, while the dual positioning ensures that support is maintained throughout the full 20-inch height. In this example, the width of each of the first and second set of rails 20, 22, 24, 26, 32, 34, 36, 38 may be about 4 inches, providing enhanced lateral support for the larger inner cores. Additionally, the rails 20, 22, 24, 26, 32, 34, 36, 38 may be made of cut flexible polyurethane foam having a density of about 2.0 pcf and an ILD of about 50 pounds-force, providing a firmer edge support characteristic suited to the premium mattress construction.

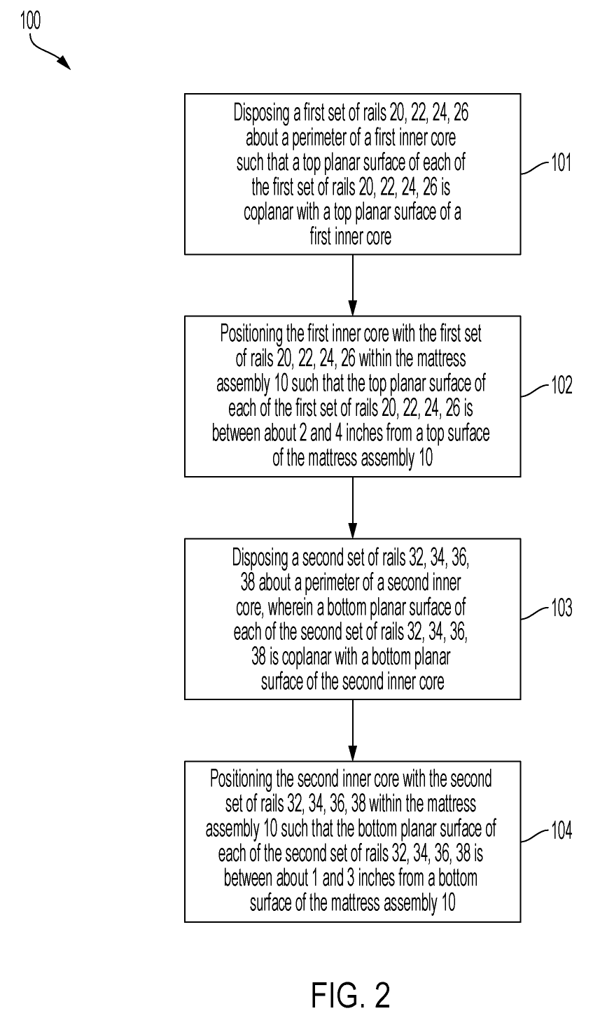

FIG. 2 is a flow-chart of a method 100 of providing edge support in a mattress assembly 10, according to an embodiment of the disclosure. As shown in FIG. 2, in Step 101, the method 100 may include disposing a first set of rails 20, 22, 24, 26 about a perimeter of a first inner core such that a top planar surface of each of the first set of rails 20, 22, 24, 26 is coplanar with a top planar surface of a first inner core. In Step 102, the method 100 may include positioning the first inner core with the first set of rails 20, 22, 24, 26 within the mattress assembly 10 such that the top planar surface of each of the first set of rails 20, 22, 24, 26 is between about 2 and 6 inches from a top surface of the mattress assembly 10. In Step 103, the method may include disposing a second set of rails 32, 34, 36, 38 about a perimeter of a second inner core, wherein a bottom planar surface of each of the second set of rails 32, 34, 36, 38 is coplanar with a bottom planar surface of the second inner core. In Step 104, the method may include positioning the second inner core with the second set of rails 32, 34, 36, 38 within the mattress assembly 10 such that the bottom planar surface of each of the second set of rails 32, 34, 36, 38 is between about 1 and 3 inches from a bottom surface of the mattress assembly 10. The mattress assembly 10 may have a total height of at least 12 inches.

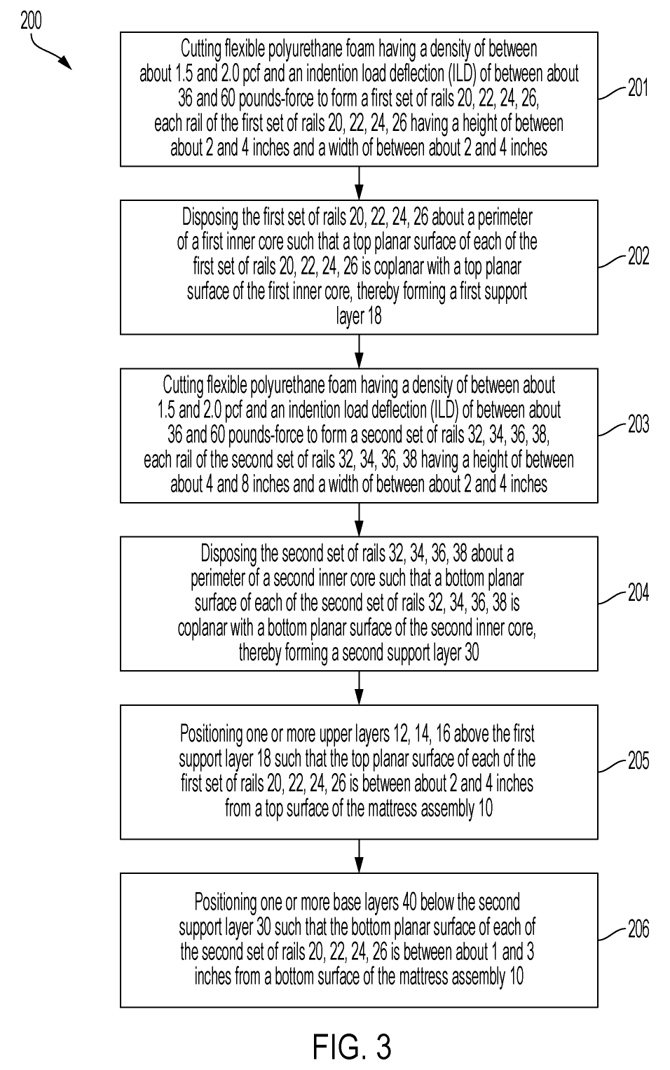

FIG. 3 is a flow-chart of a method 200 of manufacturing a mattress assembly 10, according to an embodiment of the disclosure. As shown in FIG. 3, in Step 201, the method may include cutting flexible polyurethane foam having a density of between about 1.5 and 2.0 pcf and an ILD of between about 36 and 60 pounds-force to form a first set of rails 20, 22, 24, 26, each rail of the first set of rails 20, 22, 24, 26 having a height of between about 2 and 6 inches and a width of between about 2 and 6 inches. In Step 202, the method may include disposing the first set of rails 20, 22, 24, 26 about a perimeter of a first inner core such that a top planar surface of each of the first set of rails 20, 22, 24, 26 is coplanar with a top planar surface of the first inner core, thereby forming a first support layer 18. In Step 203, the method may include cutting flexible polyurethane foam having a density of between about 1.5 and 2.0 pcf and an ILD of between about 36 and 60 pounds-force to form a second set of rails 32, 34, 36, 38, each rail of the second set of rails 32, 34, 36, 38 having a height of between about 4 and 8 inches and a width of between about 2 and 6 inches. In step 204, the method may include disposing the second set of rails 32, 34, 36, 38 about a perimeter of a second inner core such that a bottom planar surface of each of the second set of rails 32, 34, 36, 38 is coplanar with a bottom planar surface of the second inner core, thereby forming a second support layer 30. In Step 205, the method may include positioning one or more upper layers 12, 14, 16 above the first support layer 18 such that the top planar surface of each of the first set of rails 20, 22, 24, 26 is between about 2 and 6 inches from a top surface of the mattress assembly 10. In Step 206, the method may include positioning one or more base layers 40 below the second support layer 30 such that the bottom planar surface of each of the second set of rails 20, 22, 24, 26 is between about 1 and 3 inches from a bottom surface of the mattress assembly 10. Thus, the mattress assembly 10 provides dual rail edge support at both an upper region and a lower region thereof.

While the disclosure particularly shows and describes preferred examples, those skilled in the art will understand that various changes in form and details may exist without departing from the spirit and scope of the present application as defined by the appended claims. The scope of this present application intends to cover such variations. As such, the foregoing description of examples of the present application does not intend to limit the full scope conveyed by the appended claims.

What is claimed is:

1. A mattress assembly comprising:
a first inner core;
a first set of rails disposed about a perimeter of the first inner core for supporting an edge thereof, a top planar surface of each of the first set of rails being coplanar with a top planar surface of the first inner core and positioned between about 2 and 6 inches from a top surface of the mattress assembly;
a second inner core;
a second set of rails disposed about a perimeter of the second inner core for supporting an edge thereof, a bottom planar surface of each of the second set of rails being coplanar with a bottom planar surface of the second inner core and positioned between about 1 and 3 inches from a bottom surface of the mattress assembly;
wherein the first inner core with the first set of rails is vertically stacked above the second inner core with the second set of rails to provide dual rail edge support throughout a height of the mattress assembly; and
wherein the height of the mattress assembly is at least 12 inches.

2. The mattress assembly of claim 1, further comprising:
one or more upper layers positioned above the top planar surface of each of the first set of rails; and
one or more intermediate layers positioned between the first set of rails and the second set of rails.

3. The mattress assembly of claim 1, wherein a height of each of the first set of rails is between about 2 and 6 inches.

4. The mattress assembly of claim 1, wherein a height of each of the second set of rails is between about 4 and 8 inches.

5. The mattress assembly of claim 1, wherein a width of each of the first and second set of rails is between about 2 and 6 inches.

6. The mattress assembly of claim 1, wherein each of the first and second set of rails comprises flexible polyurethane foam.

7. The mattress assembly of claim 1, wherein each of the first and second set of rails has a density of between about 1.5 and 2.0 pcf.

8. The mattress assembly of claim 1, wherein each of the first and second set of rails has an indention load deflection (ILD) of between about 36 and 60 pounds-force.

9. The mattress assembly of claim 1, wherein the first set of rails comprises four rails disposed about the perimeter of the first inner core, and wherein the second set of rails comprises four rails disposed about the perimeter of the second inner core.

10. The mattress assembly of claim 1, wherein the first set of rails and the second set of rails are vertically aligned along a perimeter of the mattress assembly.

11. The mattress assembly of claim 1, wherein the first inner core and the second inner core are vertically stacked within the mattress assembly.

12. A method of providing edge support in a mattress assembly, the method comprising:
disposing a first set of rails about a perimeter of a first inner core such that a top planar surface of each of the first set of rails is coplanar with a top planar surface of a first inner core;
positioning the first inner core with the first set of rails within the mattress assembly such that the top planar surface of each of the first set of rails is between about 2 and 6 inches from a top surface of the mattress assembly;
disposing a second set of rails about a perimeter of a second inner core such that a bottom planar surface of each of the second set of rails is coplanar with a bottom planar surface of the second inner core;
positioning the second inner core with the second set of rails within the mattress assembly such that the bottom planar surface of each of the second set of rails is between about 1 and 3 inches from a bottom surface of the mattress assembly;
wherein the mattress assembly has a total height of at least 12 inches.

13. The method of claim 12, further comprising positioning one or more intermediate layers between the first set of rails and the second set of rails.

14. The method of claim 12, further comprising positioning one or more upper layers above the top planar surface of each of the first set of rails.

15. The method of claim 12, further comprising vertically aligning the first set of rails and the second set of rails along a perimeter of the mattress assembly.

16. The method of claim 12, further comprising vertically stacking the first inner core and the second inner core within the mattress assembly.

17. A method of manufacturing a mattress assembly, the method comprising:
cutting flexible polyurethane foam having a density of between about 1.5 and 2.0 pcf and an indention load deflection (ILD) of between about 36 and 60 pounds-force to form a first set of rails, each rail of the first set of rails having a height of between about 2 and 6 inches and a width of between about 2 and 6 inches;
disposing the first set of rails about a perimeter of a first inner core such that a top planar surface of each of the first set of rails is coplanar with a top planar surface of the first inner core, thereby forming a first support layer;
cutting flexible polyurethane foam having a density of between about 1.5 and 2.0 pcf and an ILD of between about 36 and 60 pounds-force to form a second set of rails, each rail of the second set of rails having a height of between about 4 and 8 inches and a width of between about 2 and 6 inches;
disposing the second set of rails about a perimeter of a second inner core such that a bottom planar surface of each of the second set of rails is coplanar with a bottom planar surface of the second inner core, thereby forming a second support layer;
positioning one or more upper layers above the first support layer such that the top planar surface of each of the first set of rails is between about 2 and 6 inches from a top surface of the mattress assembly; and
positioning one or more base layers below the second support layer such that the bottom planar surface of each of the second set of rails is between about 1 and 3 inches from a bottom surface of the mattress assembly;
wherein the mattress assembly provides dual rail edge support at both an upper region and a lower region thereof.

18. The method of claim 17, further comprising positioning one or more intermediate layers between the first set of rails and the second set of rails.

19. The method of claim 17, further comprising vertically aligning the first set of rails and the second set of rails along a perimeter of the mattress assembly.

20. The method of claim 17, further comprising vertically stacking the first inner core and the second inner core within the mattress assembly.
